(19) United States
(12) Patent Application Publication
(10) Pub. No.: US 2004/0094975 A1
(43) Pub. Date: May 20, 2004

(54) Hybrid bumper system

(76) Inventors: Stephen Shuler, Royal Oak, MI (US); Adam Trappe, Chesterfield, MI (US); Eric D. Kowal, Roseville, MI (US); Srikanth Santhanam, Windsor, MI (US); Suresh Nagesh, Bangalor (IN); Alok Nanda, Bangalore (IN); Tansen Dhananjay Chaudhari, Bangalore (IN)

Correspondence Address: Robert E. Walter, GE Plastics, One Plastics Avenue, Pittsfield, MA, 01201, US

(21) Appl. No.: 10/610,275

(22) Filed: Jun. 30, 2003

Related U.S. Application Data
(60) Provisional application No. 60/426,290, filed on Nov. 14, 2002.

(51) Int. Cl. B60R 19/03

(52) U.S. Cl. 293/120

(57) ABSTRACT

A hybrid bumper system includes a hollow reinforcing metallic beam and a molded engineering thermoplastic resin energy absorber. The energy absorber further includes at least one crushable portion. The hollow metallic beam is secured in a physically stable combination with the energy absorber, thereby resulting in a solitary hybrid bumper system.

### CROSS REFERENCE TO RELATED APPLICATIONS

This application claims priority to U.S. Provisional Application Serial No. 60/426,290 filed on Nov. 14, 2002, which is incorporated herein by reference in its entirety.

### FIELD OF THE INVENTION

The present invention generally is directed towards an automotive bumper system, and more specifically towards a hybrid bumper system incorporating metallic and thermoplastic resin materials.

### BACKGROUND OF THE INVENTION

Bumpers are a common part of most vehicles, especially cars and utility vehicles. Bumpers serve various purposes including softening impact in case of an accident, styling. Existing bumper systems are typically an assembly of several individual components, such as energy absorber, reinforcing beam, pole protectors, flange attachments, among others. Typically, these components parts include a soft energy absorber backed by a stiff reinforcing beam, to meet impact requirements in accordance with various industry standards. The stiff reinforcing beam typically formed using materials such as roll formed steel, stamped steel, extruded aluminum or compression molded glass mat thermoplastic. The beam is typically secured to supports or rails that project forwardly and are attached or form part of the frame of the vehicle. The energy absorber is typically constructed from thermoplastic foam such as expanded polypropylene. However, industry's desire for higher impact tolerance, reduction of packaging space requirements and lightweight bumper systems leaves a gap between such existing systems and what is desired. Accordingly, there exists a need for lightweight vehicle bumper systems that meet the impact standards for futuristic use and offer a reduction in packaging space, are required.

### BRIEF DESCRIPTION OF THE INVENTION

According to an embodiment of the present invention, a hybrid bumper system includes a hollow reinforcing metallic beam and a molded engineering thermoplastic resin energy absorber. The beam is adapted for attachment to supports or rails projecting outwardly from the front of a vehicle. In an embodiment, the energy absorber comprises a forwardly projecting crushable portion extending longitudinally across the beam and adapted to crush upon impact to absorb forces generated during impact. In an embodiment, the energy absorber further includes a pair of crushable members positioned at respective ends of the energy absorber in proximity to respective rails. The hollow metallic beam is secured in a physically stable combination with the energy absorber, thereby resulting in a solitary hybrid bumper system. According to an embodiment, engineering thermoplastic forming the energy absorber is molded in contact with the beam for holding the energy absorber and the beam together. According to another embodiment, the sole holding of the energy absorber to the beam is through contact of molded thermoplastic resin with the beam.

### BRIEF DESCRIPTION OF THE DRAWINGS

The foregoing and other advantages and features of the invention will become apparent upon reading the following detailed description and upon reference to the drawings in which:

FIG. 1 is a partial perspective illustration of the hybrid bumper system;

FIG. 2 is a perspective illustration of the reinforcing hollow metallic beam;

FIG. 3 is a perspective illustration of the thermoplastic energy absorber;

FIG. 4 is a cross section of combined hollow metallic beam and energy absorber showing section 4-4 of FIG. 1; and

FIG. 5 is the cross section along 5-5 of FIG. 1.

### DETAILED DESCRIPTION OF SPECIFIC EMBODIMENTS

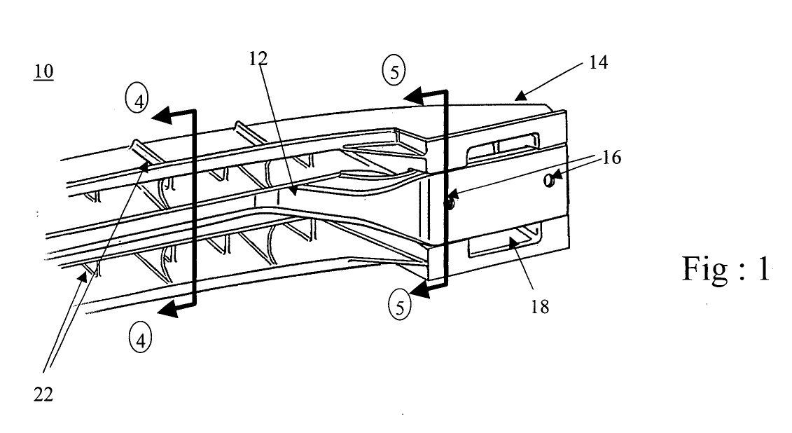

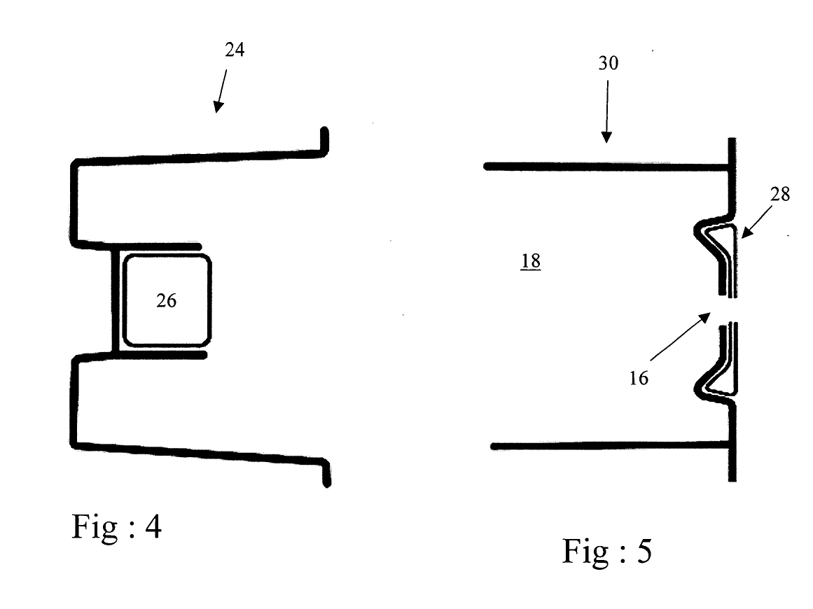

FIG. 1 shows a partial perspective view of a hybrid bumper system 10 according to an embodiment of the present invention. The hybrid bumper system 10 includes a (meaning at least one) reinforcing metallic beam 12 in combination with a thermoplastic energy absorber 14. The metallic beam 12 may be made of a single metal such as aluminum or of alloys such as steel. The thermoplastic energy absorber 14 may be a moldable engineering thermoplastic resin. The thermoplastic energy absorber 14 comprises crushable portions 15, 17 and crush members 18 and 20 positioned at the extremities. The crushable portions 15, 17 are illustrated in FIG. 1 as an upper crushable portion 15 and a lower crushable portion 17 which are positioned, respective, above and below the beam and in contact with the beam 12. The crushable portions 15, 17 extend forwardly beyond the beam so that an impact force is absorbed by the crushable portions 15, 17. As shown in FIG. 3, and in FIG. 4, the beam 12 with the cross section 26, is as least partially surrounded by the thermoplastic resin of the crushable portions 15, 17 to form a stable connection with the beam 12. The connection is formed through frictional contact between the crushable portions 15, 17 and the beam 12. It is contemplated that such frictional contact may be increased by a roughened surface on the beam or indents or projections provided on the beam to provide more gripping power.

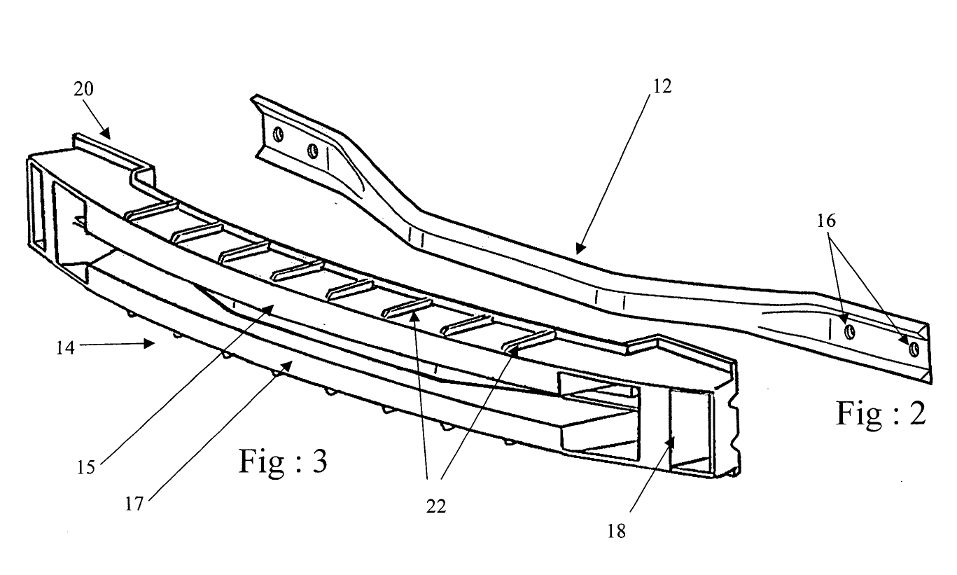

FIG. 2 shows the perspective of the reinforcing metallic beam 12 having holes 16 on both ends. It is appreciated here that the holes 16 shown at the ends are merely suggestive representations of the mechanisms to secure the energy absorber 14 and the reinforcing metallic beam 12. The holes 16 may be located in any portion of the metallic beam 12 to allow for securing the energy absorber 14. Further, the holes 16 may also be a provision for attaching the bumper system 10 to rails (not shown) for securing the bumper system 10 to the vehicle. A suitable attachment may be made by permitting injection molded thermoplastic resin to flow though the holes 16 and over the metallic beam 12 to form a gripping contact between the beam 12 and the energy absorber 14. The metallic beam 12 is a hollow metallic structure, preferably hydroformed into a suitable shape, providing strength to the bumper system 10, while satisfying the requirement of being lightweight. Hydroforming is a well-known process in the art that uses pressurized fluid to deform a closed channel structural member into a desired shape. To accomplish this, the closed channel structural member, such as a hollow metallic rod, is initially disposed between two die sections of a hydroforming apparatus that, when closed together, define a die cavity having a desired final shape. Thereafter, the closed channel structural member is filled with a pressurized fluid, typically a relatively incompressible liquid such as water. The pressure of the fluid is increased to a magnitude where the closed channel structural member is expanded or otherwise deformed outwardly into conformance with the die cavity. As a result, the closed channel structural member is deformed into the desired final shape. The final shape may be square, rectangular, oval, or round. In the illustration set forth herein, the hydroform bumper beam is shown as being essentially square (in FIGS. 2 and 4) but should not be considered as limited thereto. It will be further appreciated that while hydroforming is preferred process for forming the metal bumper, other processes such as, for example, extrusion may be employed for providing the hollow metallic beam.

Referring now to FIG. 3, a perspective view of the energy absorber 14 illustrates the crushable members or crushable cones or cans 18, 20 at either end. It is contemplated that the crushable members 18 and 20 may have a variety of shapes. The crushable members 18, 20 lie in a horizontal plane of the energy absorber 14, and are operational to protect the rails (not shown) upon impact. Ribs 22 formed throughout the structure advantageously provide rigidity to the energy absorber 14, which is a engineering thermoplastic resin, molded by various techniques, such as, for example, injection molding. The engineering thermoplastic resin may be a combination of an aromatic polycarbonate and polyester such as, for example, polybutylene terepthalate, polyethylene terepthalate, or a combination of the two. It will be appreciated here that such resins are well known in the art and include, without limitation, materials such as aromatic polycarbonate; copolyester carbonate; polyester such as polybutylene terepthalate, polyphenylene ether; polyurethane; polyethylenes (high density and low density linear polyethylenes); polypropylenes; polysulphones; acrylates (homo and copolymers) such as polyethyl methacylate, polymethylmethacrylate and the like; blends of the above; blends thereof with an elastomeric polymer and blends thereof with other polymers such as polycarbonate/polybutylene terephthalate, polyphenylene ether, high impact polystyrene, polycarbonate/acrylonitride-butadiene-styrene, and the like.

FIGS. 4 and 5 show the cross section of the hybrid bumper system of FIG. 1 along sections 4-4 and 5-5. FIG. 4 illustrates the cross section of the middle area of the hybrid bumper system 10, with a “W” shaped cross section 24 of the energy absorber 14 and a rectangular cross section 26 of the hollow metallic beam 12. FIG. 5 illustrates the cross section near the end of the bumper system, over a crush member, showing the cross section of the crush member zone 30 and the cross section of the metallic beam 28 over the crush member. The discontinuity in FIG. 5 corresponds to the space for holes 16, as depicted earlier. It is appreciated here that this discontinuity is dependent on the placement of the hole, and may not be present in certain other embodiments of the invention.

In one embodiment of the invention, the hybrid bumper system 10 is made by over-molding the hollow metallic beam with engineering thermoplastic resin using injection molding technique, thus obtaining a singular object. In another embodiment, the hydroformed metallic beam and the molded energy absorber may be made separately, and then assembled into a solitary bumper beam system. The thermoplastic energy absorber may be formed, in addition to the injection molding and blow molding, using compression molding or thermloforming techniques. These combination techniques advantageously make the arrangement compact. It will be appreciated here that any molding technique may be utilized, and as such the molding methodology does not affect the scope of the invention.

The hybrid bumper system 10 is advantageously designed to protect other components of the vehicle such as longitudinal rails (not shown). Upon impact, the metallic reinforcing beam 12 provides strength to the bumper system, whereas the energy absorber 14 provides stiffness. Additionally, the crush cans 18, 20 advantageously deform upon impact, in preference to the longitudinal rails, absorbing the force of the impact. The crush cans 18, 20 and the energy absorber 14, are desirably adapted to substantially return to their respective original shape once the impact is over. Thus, the bumper system 10 provides effective impact tolerance, at the same time being lightweight and compact.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A hybrid bumper system comprising:
at least one hydroformed hollow reinforcing metallic beam;
a thermoplastic energy absorber having at least one crushable portion, said metallic beam and said energy absorber being held together in a physically stable arrangement at least partially by contact between said metallic beam and said energy absorber.

2. The bumper system of claim 1, wherein the metallic beam is made of a single metal and includes a forwardly projection hollow central portion for contacting said energy absorber and end portions for attachment to vehicle support members.

3. The bumper system of claim 2, wherein the beam is made of aluminum.

4. The bumper system of claim 1, wherein the metallic beam is made of an alloy.

5. The bumper system of claim 4, wherein the metallic beam is made of steel.

6. The bumper system of claim 1, wherein the molded energy absorber is injection molded in contact with at least a portion of said metallic beam.

7. The bumper system of claim 1, wherein the hollow metallic beam is a closed channel hydroformed metal beam.

8. The bumper system of claim 1, wherein the thermoplastic energy absorber is made of a resin comprising in combination an aromatic polycarbonate and a polyester.

9. The bumper system of claim 8, wherein the polyester comprises at least one of polybutylene terepthalate and polyethylene terepthalate.

10. A method of making a hybrid bumper system comprising the step of forming an energy absorber by over-molding a hydroformed hollow metallic beam with an engineering thermoplastic resin.

11. The method of claim 10, wherein over-molding involves forming said energy absorber by injection molding the engineering thermoplastic over the metallic beam, said energy absorber being held to said beam primarily by contact between said beam and said energy absorber.

12. The method of claim 10, wherein the hydroformed metallic beam has a central projecting portion, and said beam is positioned in contact with at least one crushable portion for holding said at least one crushable portion and said beam together.
